(19) United States
(12) Patent Application Publication
(10) Pub. No.: US 2014/0208058 A1
(43) Pub. Date: Jul. 24, 2014

(54) STORAGE DEVICE, AND METHOD OF CONTROLLING THE SAME

(71) Applicant: Sony Corporation, Tokyo (JP)

(72) Inventors: Akira Fujisawa, Tokyo (JP); Tomonori Masumura, Kanagawa (JP)

(73) Assignee: Sony Corporation, Tokyo (JP)

(21) Appl. No.: 14/156,931

(22) Filed: Jan. 16, 2014

(30) Foreign Application Priority Data
Jan. 23, 2013 (JP) 2013-009982

(51) Int. Cl. G06F 12/02

(52) U.S. Cl. CPC G06F 12/0223
USPC 711/173

(57) ABSTRACT

A storage device includes: a storage medium; and a control section configured to prompt a host apparatus to perform formatting of the storage medium in accordance with a change of a number of divisions of a storage area of the storage medium.

### CROSS REFERENCE TO RELATED APPLICATIONS

This application claims the benefit of Japanese Priority Patent Application JP 2013-009982 filed Jan. 23, 2013, the entire contents of which are incorporated herein by reference.

### BACKGROUND

The present disclosure relates to a storage device, and a method of controlling the storage device. In particular, the present disclosure relates to a storage device capable of changing the number of divisions of a storage area of a storage medium, and a method of controlling the storage device.

Hard disk drives (HDDs) have become widespread for storing data, such as image data, audio data, and the like. In recent years, the quality of these data have improved significantly, and thus a larger capacity is further demanded for the hard disk drives.

In order to meet this demand, hard disk drives having a large capacity of 3 TB have already been produced on the market. However, there are apparatuses that are not allowed to use all of a hard disk drive having a capacity of 3 TB, and are limited to use up to a capacity of 2 TB depending on a host apparatus (for example, a television apparatus).

Accordingly, a proposal has been made of a hard disk drive having a mode change function. As illustrated in FIG. 11, in this hard disk drive, it is possible to change a mode between a whole mode in which an internal hard disk of 3 TB is entirely used, and a division mode in which the internal hard disk is divided and used for 1 TB or 2 TB using an operation section. Hereinafter, a division mode of 1 TB is referred to as a 1-TB mode, and a division mode of 2 TB is referred to as a 2-TB mode.

In the division mode, the storage area of a hard disk is logically divided into two partitions so that it is possible to handle each of the divided partitions as a virtually independent drive. Accordingly, using the latter mode out of the whole mode and the division mode, it is possible for a host apparatus that is limited to use a hard disk drive up to a capacity of 2 TB to use a hard disk drive having a large capacity of 3 TB. Japanese Unexamined Patent Application Publication No. 2004-348195 has disclosed a technique for dividing and managing the storage area of a hard disk drive having a large capacity as described above.

### SUMMARY

In the above-described hard disk drive, if the operation section make a mode change between the whole mode and the division mode, it becomes necessary for a user to format the hard disk drive using a host apparatus, such as a personal computer (PC), or the like after the mode change. In this manner, by performing formatting, it is possible to correctly operate a hard disk drive in a mode after a mode change.

However, in the above-described hard disk drive, even if formatting is not carried out after the mode change, it is possible to use the hard disk drive. Accordingly, there is a possibility that the user is not aware of the fact that a mode change has not been performed normally.

For example, there is a possibility that the user is not aware of the following state. In the above-described hard disk drive, as illustrated in FIG. 11, the same physical area is referenced as LBA0 both in the 3-TB mode and the 2-TB mode. Accordingly, in the case of changing from the 2-TB mode to the 3-TB mode, it is possible to use the area that was used in the 2-TB mode without change, and thus the user might not be aware of the fact that an expanded 1-TB mode is not used.

Also, the user might recognize the state of a hard disk drive as follows. For example, if the user changed the mode from the 1-TB mode to the 3-TB mode to use the hard disk drive, and then returned the mode from the 3-TB mode to the 1-TB mode again, the user might be able to use the 1-TB mode as before. In this case, there is a possibility that the user mistakenly recognizes the hard disk drive to be allowed to use 4 TB, which is the sum of 3 TB and 1 TB. Also, when the user has changed the mode from the 1-TB mode to the 3-TB mode, and is using the hard disk drive, if writing data occurs in the area of the 1-TB mode, there is a risk that a file stored in the are of the 1-TB mode might be deleted against the user's intention.

Accordingly, it is desirable to provide a storage device capable of carrying out a normal mode change more reliably, and a method of controlling the storage device.

According to an embodiment of the present disclosure, there is provided a storage device including: a storage medium; and a control section configured to prompt a host apparatus to perform formatting of the storage medium in accordance with a change of a number of divisions of a storage area of the storage medium.

According to another embodiment of the present disclosure, there is provided a method of controlling a storage device, the method including: in accordance with a change of a number of divisions of a storage area of a storage medium, prompting a host apparatus to perform formatting of the storage medium.

By the present technique, the control section prompts a host apparatus to format the storage medium in accordance with a change of the number of divisions of the storage area of the storage medium. It is possible to carry out a normal mode change by executing formatting of the storage medium in response to this prompting.

As described above, it is possible to carry out a normal mode change more reliably by the present technique.

### BRIEF DESCRIPTION OF THE DRAWINGS

FIG. 1 is a block diagram illustrating an example of a configuration of a storage device according to a first embodiment of the present technique;

FIG. 2A is a diagram illustrating an example of a format organization of a storage medium;

FIG. 2B is a diagram illustrating an example of a format organization of a master boot record;

FIG. 3 is an explanatory diagram of modes of a storage device according to the first embodiment of the present technique;

FIG. 4 is a diagram for explaining an example of address conversion processing of a controller;

FIG. 5 is a flowchart for explaining an example of operation of a storage device according to the first embodiment of the present technique;

FIG. 6 is an explanatory diagram of modes of a storage device according to a second embodiment of the present technique;

FIG. 7 is a flowchart for explaining an example of operation of a storage device according to the second embodiment of the present technique;

FIG. 8 is a flowchart for explaining an example of operation of a storage device according to a third embodiment of the present technique;

FIG. 9 is a diagram illustrating an example of a first division mode, and a second division mode;

FIG. 10 is a diagram illustrating an example of a whole mode, a first division mode, and a second division mode; and

FIG. 11 is an explanatory diagram of a mode change function.

### DETAILED DESCRIPTION OF EMBODIMENTS

Descriptions will be given of embodiments of the present technique with reference to the drawings in the following order.

1. First embodiment (first example of storage device)

2. Second embodiment (second example of storage device)

3. Third embodiment (third example of storage device)

4. Variations

### 1. First Embodiment

Configuration of Storage Device

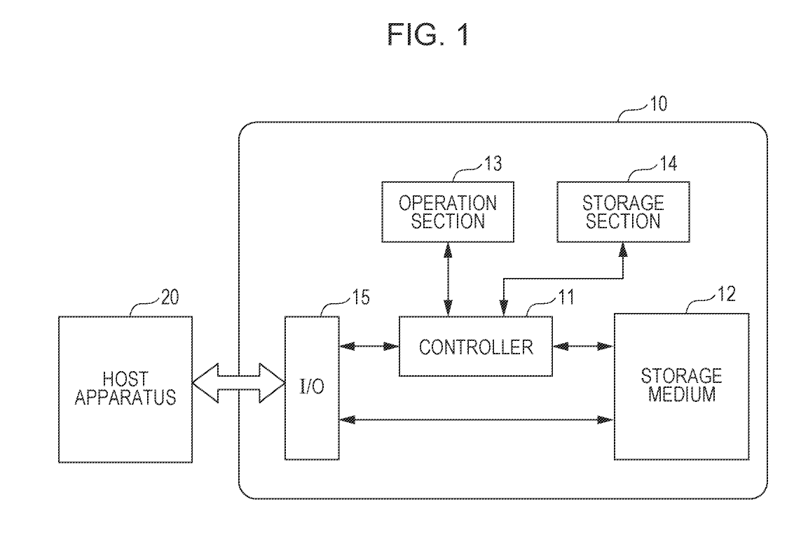

FIG. 1 is a block diagram illustrating an example of a configuration of a storage device according to a first embodiment of the present technique. As illustrated in FIG. 1, the storage device 10 includes a controller (control section) 11, a storage medium 12, an operation section 13, a storage section 14, and an input/output section 15.

The storage device 10 is a magnetic storage device, such as a hard disk drive (HDD), or the like, for example, or a semiconductor storage device, such as a solid state drive (SSD), or the like.

The storage device 10 is connected to the host apparatus 20. For the host apparatus 20, a consumer electronics device (CE device), such as a television apparatus, an optical disc recorder (for example, a Blu-ray Disc (a registered trademark) recorder, or a DVD (Digital Versatile Disc) recorder), a personal computer (PC) or the like, for example is used.

Storage Medium

The storage medium 12 is a storage medium, such as a magnetic storage medium or a semiconductor storage medium, or the like, for example. The magnetic storage medium includes one or more magnetic disks (for example, a platter), and so on, for example. The semiconductor storage medium includes one or more flash memories, for example.

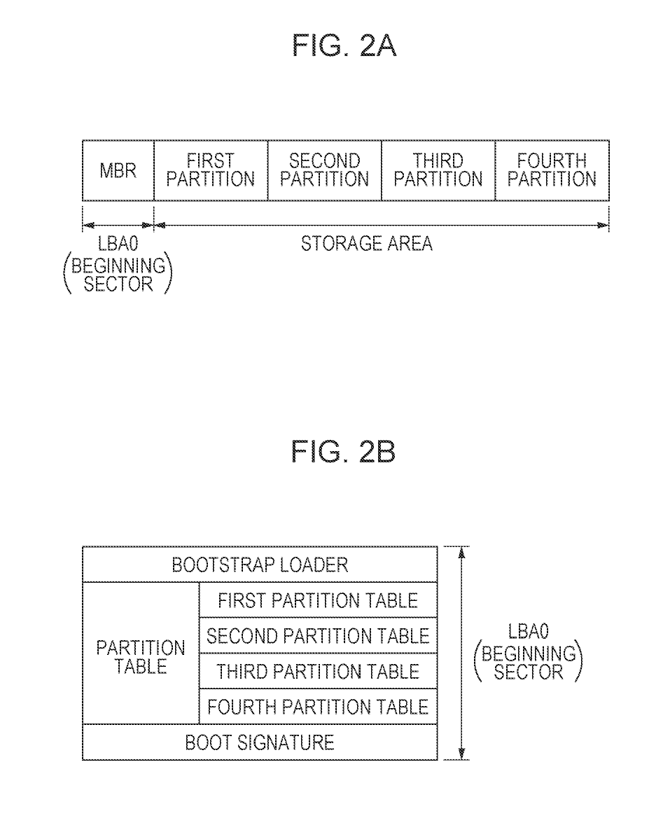

FIG. 2A is a diagram illustrating an example of a format organization of a storage medium. As illustrated in FIG. 2A, the storage medium 12 includes a master boot record (MBR) area, which is a start-information storage area, and a storage area for storing content information, such as a moving image, a still image, and the like. A MBR area is disposed in the beginning sector (LBA (Logical Block Addressing)=0 sector) of the storage medium 12. The storage area is disposed in an area following the beginning sector. Hereinafter, a divided storage area is suitably referred to as a partition.

When the storage device 10 is used as an external storage device, for example, the host apparatus 20 first refers to the MBR which is located at the beginning (LBA0) of the storage medium 12, and grasps the logical configuration of the storage device 10.

FIG. 2B is a diagram illustrating an example of the format organization of the master boot record. As illustrated in FIG. 2B, the MBR, which is start information, includes a bootstrap loader, which is a start program, the first to the fourth partition tables (boot tables), which provide division information, and a boot signature, which is assurance information.

The bootstrap loader is a start program that loads a partition boot record (PBR) located at the beginning sector (boot sector) of a partition.

The first to the fourth partition tables include information on the corresponding storage areas that are logically divided, that is to say, information on the first to the fourth partitions, respectively. Specifically, each of the first to the fourth partition tables includes a boot flag, a partition type, a partition start position, a partition end position, and the total number of sectors of the partition.

The storage area is divided into any one of one to four partitions, for example. In this regard, FIG. 2A illustrates an example in which the storage area is divided into four partitions. The first to the fourth partitions of the storage medium 12 are managed by the first to the fourth partition tables, respectively.

The boot signature includes a signature (assurance information) that assures the validity of the MBR. This signature is a fixed value called a magic number. If the fixed value is not written, the MBR is regarded as invalid, and the bootstrap loader is not executed.

When the host apparatus 20, such as a PC, or the like receives the MBR that has been read from the beginning sector (LBA=0 sector), the following processing is mainly performed. First, a determination of whether MBR is valid or not is made by checking the boot signature. If the MBR is determined to be valid, the bootstrap loader is executed, and the first to the fourth partition tables are checked in order to find a bootable partition (storage area). If a bootable partition is found, the beginning position of the area is obtained from the partition table. Next, a PBR located in the beginning sector of the partition is loaded on the basis of the obtained beginning position. On the other hand, if the MBR is determined to be invalid, information for prompting the user to format the storage device 10 is output.

Operation Section

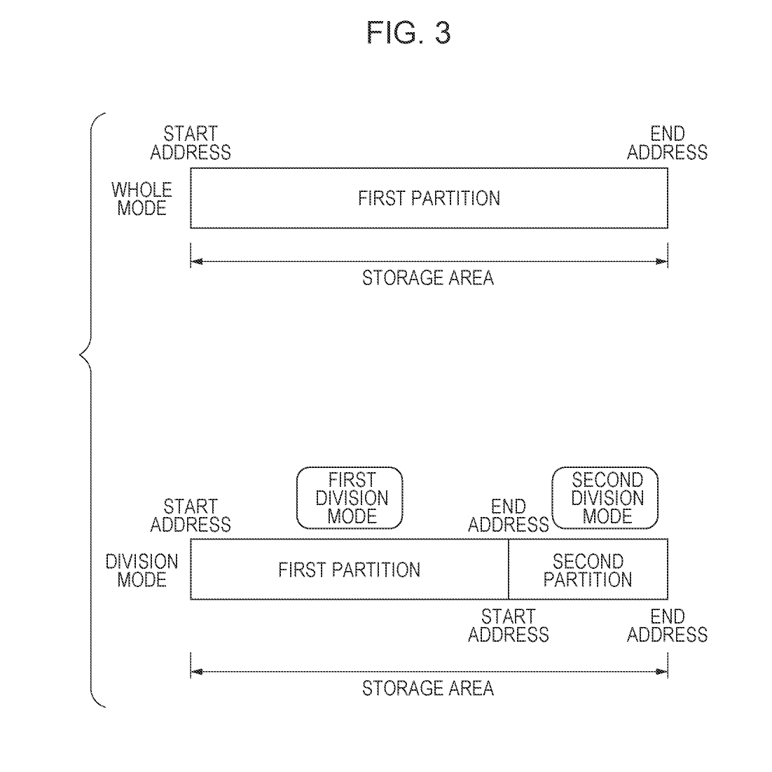

FIG. 3 is an explanatory diagram of modes of a storage device according to the first embodiment of the present technique. The operation section 13 is a switch for changing the use modes of the storage device 10. As illustrated in FIG. 3, the modes include a whole mode (first mode), and a division mode (second mode), for example.

The whole mode is a control method in which the storage area of the storage medium 12 as one medium is managed as a whole, and which allows the storage device 10 to be used as one storage device without change. In the whole mode, the address (LBA) of the storage area of the storage medium 12 is managed by one of the partition tables (for example, the first partition table).

The division mode is a control method in which the storage area of the storage medium 12 as one medium is divided into a plurality of storage areas and managed, and which allows the storage device 10 to be used as a plurality of independent virtual storage devices individually. In the division mode, the address (LBA) of the storage area of the storage medium 12 is divided into the partition tables (for example, the first and the second partition tables in the case of two divisions) corresponding to the number of divisions (the number of partitions) of the storage area, and managed. Here, the number of divisions “1” means that the storage area of the storage medium 12 as one medium is managed undividedly as a whole. In this regard, FIG. 3 illustrates, as an example, a division mode in which the storage area of the storage medium 12 as one medium is divided into two parts, namely a first half and a last half in order to use the storage device 10 as two virtual storage devices. However, the number of divisions of the storage area of the storage medium 12 is not limited to this.

In the following, a description will be given of the case where the storage area of the storage medium 12 is logically divided into two parts and managed in the division mode as an example in order to simplify the description. When the storage area of the storage medium 12 as one medium is divided into the first partition table (the first storage area) and the second partition table (the second storage area), the mode of using the first partition table out of those partitions is referred to as a division mode (A), and the mode of using the second partition is referred to as a division mode (B). In the case where the storage capacity of the storage medium 12 is 3 TB, for example the division mode (A) is a 2-TB mode having a storage capacity of 2 TB, and the division mode (B) is a 1-TB mode having a storage capacity of 1 TB.

The mode change includes a mode change (a) in which a change occurs in the number of divisions (the number of partitions) of the storage area of the storage medium 12, and a mode change (b) in which a change does not occur in the number of divisions (the number of partitions) of the storage area of the storage medium 12. The mode change (a) is specifically a mode change between the whole mode and the division mode. The mode change (b) is specifically a mode change between the plurality of division modes, namely a mode change between the division mode (A) and the division mode (B), for example.

In the case where the mode change is the mode change (a), it is necessary to newly format the storage medium 12, whereas in the case where the mode change is the mode change (b), it is not necessary to newly format storage medium 12. In the case where the mode change is the mode change (a), if the storage medium 12 is not newly formatted, a normal mode change is not performed as described above. Accordingly, in the storage device 10 according to the present embodiment, when the mode change is the mode change (a), the host apparatus 20 is prompted to format the storage medium 12. In response to this prompt, the user formats the storage device 10 so that the user is allowed to reliably perform a normal mode change.

Input/Output Section

The input/output section 15 is connected to an input/output section of the host apparatus 20. Through the input/output section 15, data, such as a moving image, a still image, and the like, and various instructions are supplied from the host apparatus 20 to the storage device 10. Also, through the input/output section 15, data, such as a moving image, a still image, and the like, and various requests are supplied from the storage device 10 to the host apparatus 20.

Storage Section

The storage section 14 stores, for example, a currently operating mode and an invalid MBR, which is pseudo data. Here, the invalid MBR is an MBR including an invalid boot signature (invalid assurance information). For the storage section 14, it is preferable to use a nonvolatile memory. FIG. 1 illustrates an example of a configuration in which the storage section 14 is disposed at the outside of the controller 11. However, the configuration of the storage device 10 is not limited to this, and the storage section 14 may be disposed inside the controller 11.

Controller

The controller 11 performs, for example, servo control of a motor and a head which are omitted to be illustrated in FIG. 1, positioning, writing voltage control in accordance with and a track position, data input/output control, cache control, and the like.

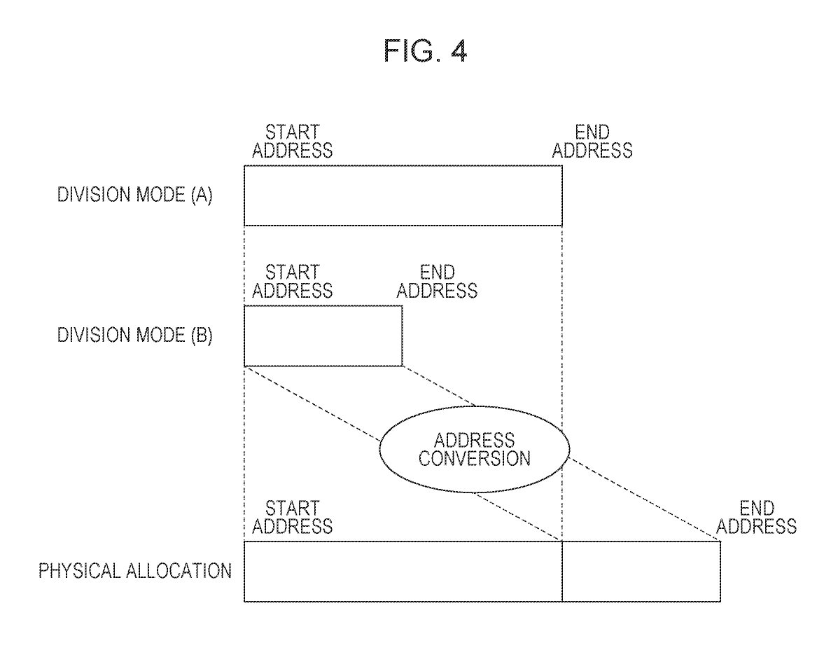

FIG. 4 is a diagram for explaining an example of address conversion processing of the controller. The controller 11 controls information to be notified to the host, such as the size of the storage medium 12, the maximum value and the valid range of address (LBA), for example. As illustrated in FIG. 4, the controller 11 converts a writing and reading address (LBA) from the host apparatus 20 into an actual physical address (LBA). Thereby, it is possible to cause the host apparatus 20 to recognize the storage device 10 as a plurality of storage devices that are independent individually.

The controller 11 stores and manages the currently operating mode in the storage section 14. If the controller 11 detects a mode change, the controller newly stores and manages a mode after the change in place of the mode before the change in the storage section 14.

The controller 11 detects whether there has been a mode change operation of by the operation section 13 or not. Specifically, the controller 11 detects whether there has been the mode change (a), in which there is a change in the number of divisions of the storage area of the storage medium 12, or the mode change (b), in which there is no change in the number of divisions of the storage area of the storage medium 12. If the controller 11 detects the mode change (a), the controller 11 prompts the host apparatus 20 to format the storage device 10 in accordance with an instruction to read the MBR (beginning sector) after that. On the other hand, if the controller 11 detects the mode change (b), the controller 11 changes the partition to store data. For example, the controller 11 changes the storage area to store data from the first partition to the second partition.

For example, prompting the host apparatus 20 to perform formatting is carried out by notifying the host apparatus 20 that the MBR is invalid in response to the reading of the MBR from the beginning sector (LBA0). The host apparatus 20 that has received such a notification outputs information to prompt the user to format the storage device 10. In accordance with this information, the user executes formatting of the storage device 10 so that the data used before the mode change becomes unrecognized. In this regard, the invalid MBR includes a corrupted state of the MBR.

More specifically, prompting the host apparatus 20 to perform formatting is carried out by outputting an invalid boot signature (invalid assurance information) to the host apparatus 20 in response to the reading of the MBR from the beginning sector (LBA0). The host apparatus 20 that has received such output outputs information to prompt the formatting of the storage device 10 to the user. An invalid MBR and/or an invalid boot signature is generated by the controller 11, or is stored in the storage section 14 in advance and maintained, for example.

Operation of Storage Device

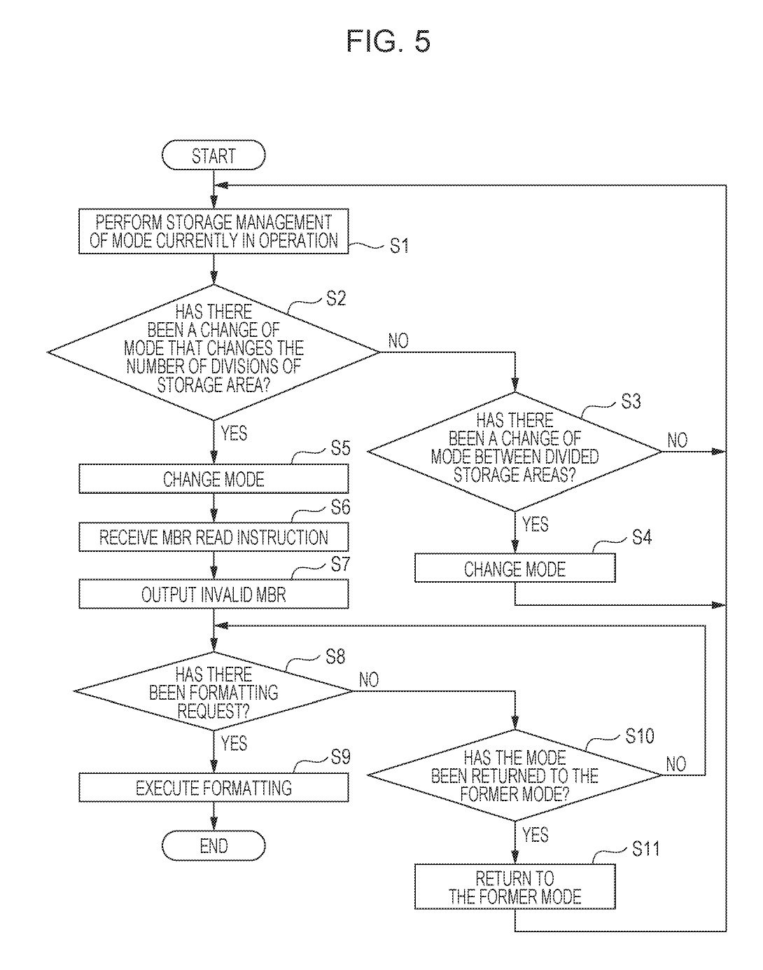

FIG. 5 is a flowchart for explaining an example of operation of a storage device according to the first embodiment of the present technique.

First, in step S1, the controller 11 performs storage management of the mode currently in operation, such as the 3-TB mode, the 2-TB mode, and the like. Next, in step S2, the controller 11 determines whether there has been an operation of mode change (a) by the operation section 13. Here, the mode change (a) means a mode change, in which there is a change in the number of divisions (the number of partitions) of the storage area of the storage medium 12 as described above. Specifically, the controller 11 determines whether there has been a mode change operation between the whole mode and the division mode by the operation section 13 (refer to FIG. 3).

In step S2, if determined that there has not been a mode change (a), in step S3, the controller 11 determines whether there has been a mode change (b) by the operation section 13 or not. Here, the mode change (b) means a mode change, in which there is not a change in the number of divisions (the number of partitions) of the storage area of the storage medium 12 as described above. Specifically, the controller 11 determines whether there has been a mode change operation between the division modes by the operation section 13 (for example, the first division mode and the second division mode) (refer to FIG. 3). In step S3, if there has been an operation of the mode change (b), in step S4, the controller 11 changes the mode being subjected to storage management, and the processing is returned to step S1. In step S3, if determined that there is no mode change, the controller 11 returns the processing to step S1.

In step S2, if determined that there has been a mode change (a) operation, the controller 11 changes the mode of storage management in step S5. Next, in step S6, when the controller 11 receives an instruction to read information (for example, MBR) of the area indicated by LBA0, which is the beginning sector, the controller 11 outputs an invalid MBR to the host apparatus 20. The invalid MBR is generated by the controller 11, or is read from the storage section 14 that has been stored the invalid MBR in advance. The invalid MBR includes an invalid boot signature.

Here, a description has been given of the example of outputting an invalid MBR to the host apparatus 20. However, only an invalid boot signature may be output to the host apparatus 20. In this case, the invalid boot signature is generated by the controller 11, or is read from the storage section 14 where the invalid boot signature has been stored in advance.

The host apparatus 20 that has received the invalid MBR outputs information prompting the user to format the storage device 10. For example, if the host apparatus 20 is a television apparatus or a PC, the information prompting the user to format the storage device 10 is displayed on the display device of the apparatus. The host apparatus 20 requests the storage device 10 to perform formatting in response to the operation of the user. In this regard, the host apparatus 20 that has received the invalid MBR may automatically make a request of formatting to the storage device 10 by software processing, such as an operating system (OS), and so on without the operation of the user.

Next, in step S8, the controller 11 determines whether there has been a formatting request from the host apparatus 20. In step S8, if determined that there has been a formatting request, the controller 11 formats the storage medium 12 in step S9. Here, the formatting is the formatting conforming to the mode changed in step S5 (for example, the whole mode or the division mode).

In step S8, if determined that there has not been a request of formatting, in step S10, the controller 11 determines whether an operation to return to the mode before the mode change again has been performed by the operation section 13. In step S10, if determined that there has been the operation to return to the mode before the mode change again, in step S11, the controller 11 returns the storage management mode to the mode before the mode change. In step S10, if determined that there has not been the operation to return to the mode before the mode change again, the controller 11 returns the processing to step S8. In this regard, after the controller 11 has detected the mode change (a), and has changed the storage management mode, the controller 11 maintains the MBR before the mode change, that is to say, without rewriting the partition table until writing occurs in the storage medium 12. Thereby, in the case where a mode change is made by operation mistake, and so on, it is possible to use the storage device 10 in the state of the mode before the mode change by returning the mode once again.

Advantages

In the storage device 10 according to the first embodiment, the MBR (start information) including an invalid boot signature (assurance information) is output to the host apparatus 20 in response to the detection of the mode change (a) between the whole mode and the division mode. The host apparatus 20 that has received this MBR recognizes that the MBR is invalid on the basis of the invalid boot signature included in the MBR. That is to say, the host apparatus 20 recognizes that the storage device 10 is in a state in which formatting is necessary (for example, a state in which a boot table is corrupted). The host apparatus 20 outputs information prompting the user to format the storage device 10 on the basis of this recognition. On the basis of this information, it is possible for the user to format the storage device 10 through the host apparatus 20. Accordingly, it is possible to properly operate the storage device 10 in the mode after the mode change. Also, the user consciously formats the storage device 10 after the mode change so that the user is allowed to clearly understand that the data stored in the storage medium 12 before the mode change has become not available.

Until writing is performed on LBA0 by formatting, or the like, reading the MBR after the mode change, that is to say, reading data from the beginning sector (LBA0) is carried out by the controller tentatively. Accordingly, the MBR before the mode change is maintained on the storage medium 12 without change. Accordingly, until a write instruction is given on the MBR by formatting, or the like, it is possible to read the MBR before the mode change by returning the mode to the previous mode. It is therefore possible to maintain user data in the case of a mode change by operation mistake, or the like.

### 2. Second Embodiment

Configuration of Storage Device

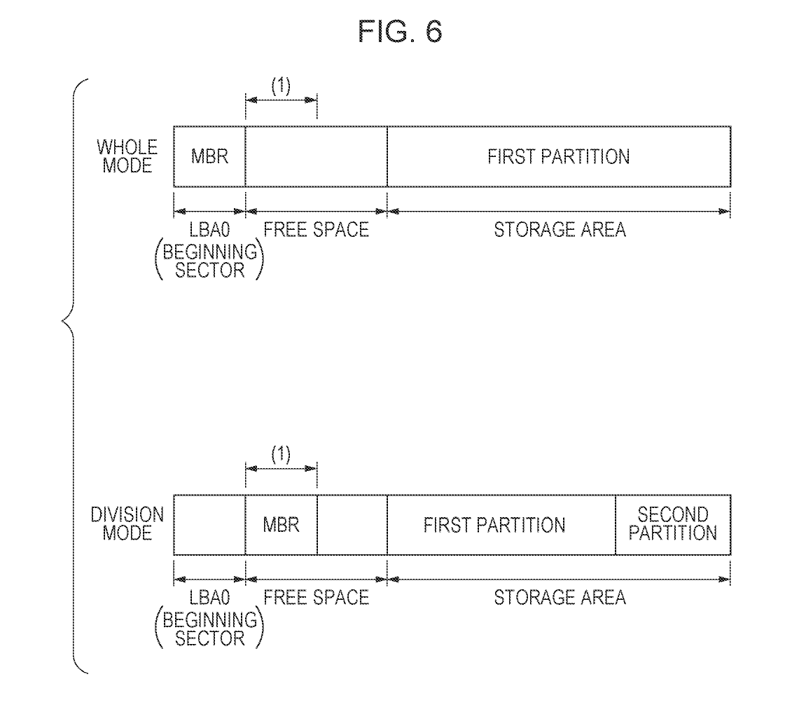

FIG. 6 is an explanatory diagram of modes of a storage device according to a second embodiment of the present technique. As illustrated in FIG. 6, a storage device 10 according to the second embodiment is different from that of the first embodiment in the point that an offset of the MBR area, which is a start information storage area, is different between the whole mode (first mode) and the division mode (second mode). Accordingly, the offsets of the areas in which the partition tables (boot tables), the boot signature, and so on are stored are also different.

For example, in one of the whole modes and the division modes, the MBR is included in the beginning sector (LBA=0 sector), whereas in the other of the modes, the MBR is included in a sector subsequent to the beginning sector (LBA=N sector, N is an integer of 1 or more). In this regard, FIG. 6 illustrates an example in which the MBR is included in the beginning sector (LBA=0 sector) in the whole mode, whereas the MBR is included in a sector subsequent to the beginning sector (LBA=N sector, N is an integer of 1 or more) in the division mode.

Normally, a free space (reserved area) is disposed between the beginning sector and the storage area. In the case of disposing the MBR in a sector subsequent to the beginning sector, it is preferable to dispose the MBR in the above-described free space. Thereby, it is possible to prevent a decrease in the capacity of the storage area, which is otherwise caused by disposing the MBR in a sector subsequent to the beginning sector. Also, it becomes unnecessary to change the format organization of the storage area, which otherwise becomes necessary by disposing the MBR in a sector subsequent to the beginning sector.

In this regard, the controller 11 converts the write and read address (LBA) of the MBR from the host apparatus 20 into different MBRs having offsets depending on the whole mode (first mode) and the division mode (second mode).

Operation of Storage Device

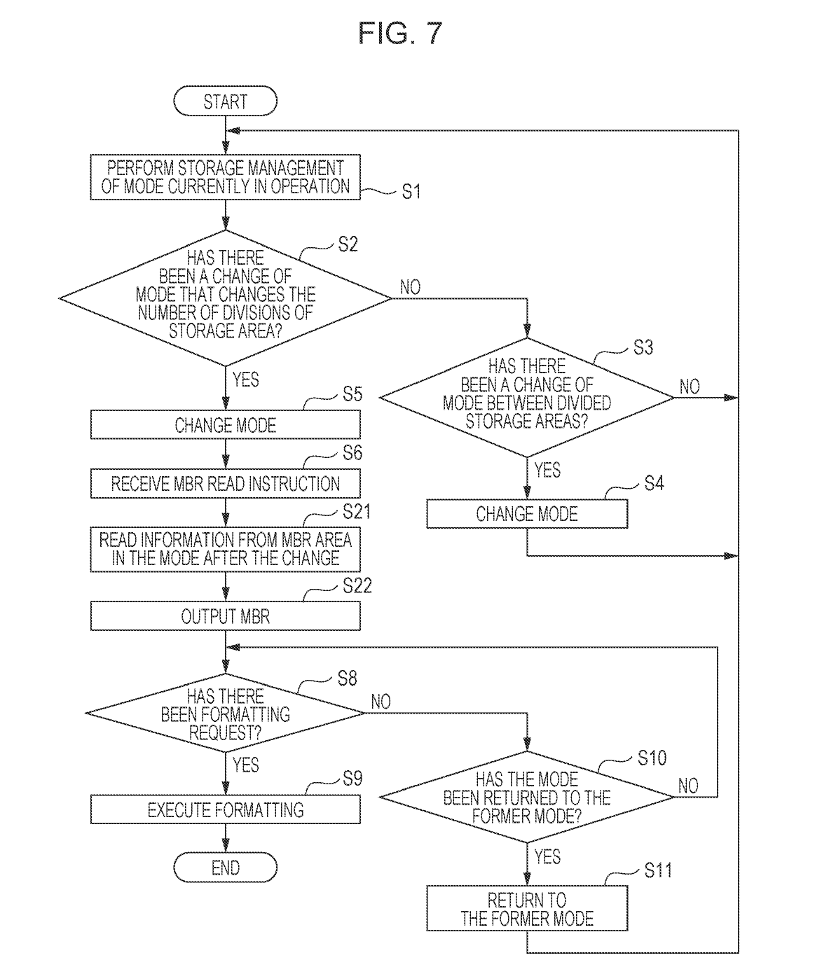

FIG. 7 is a flowchart for explaining an example of operation of a storage device according to the second embodiment of the present technique. The operation of the storage device according to the second embodiment of the present technique is the same as that of the first embodiment except that steps S21 and S22 are provided in place of the step S7 illustrated in FIG. 5. Accordingly, a description will be only given of steps S21 and S22 in the following.

First, in step S6, when the controller 11 receives a read instruction (for example, a read instruction of the beginning sector) of the MBR from the host apparatus 20, in step S21, the controller 11 reads information from a position of the MBR area corresponding to the mode after the change. As illustrated in FIG. 6, the offset of the MBR area before the mode change and after the mode change are different, and thus the information is read from a position that is shifted from the storage position of the MBR before the mode change. That is to say, an invalid MBR is read. For example, if the mode change is a change from the whole mode to the division mode, information is read from an area (1) having a different offset from that of the MBR area of the whole mode before the mode change. On the other hand, if the mode change is a change from the division mode to the whole mode, information is read from the beginning sector (LBA0) having a different offset from that of the MBR area of the division mode before the mode change.

Next, in step S22, the controller 11 determines the information that has been read in step S21 to be a MBR, and outputs the MBR to the host apparatus 20. The information that has been read in step S21 is an invalid MBR, and thus the boot signature also becomes an invalid boot signature.

Here, a description will be given of an example of outputting an invalid MBR to the host apparatus 20. However, only an invalid boot signature may be output to the host apparatus 20.

Advantages

After the mode change, the storage device according to the second embodiment reads information at a position shifted from the storage position of the MBR before the mode change, and outputs the information as the MBR to the host apparatus 20 in order to promote the host apparatus 20 to perform formatting. Accordingly, it is possible to obtain the same advantages as those in the first embodiment described above.

### 3. Third Embodiment

Operation of Storage Device

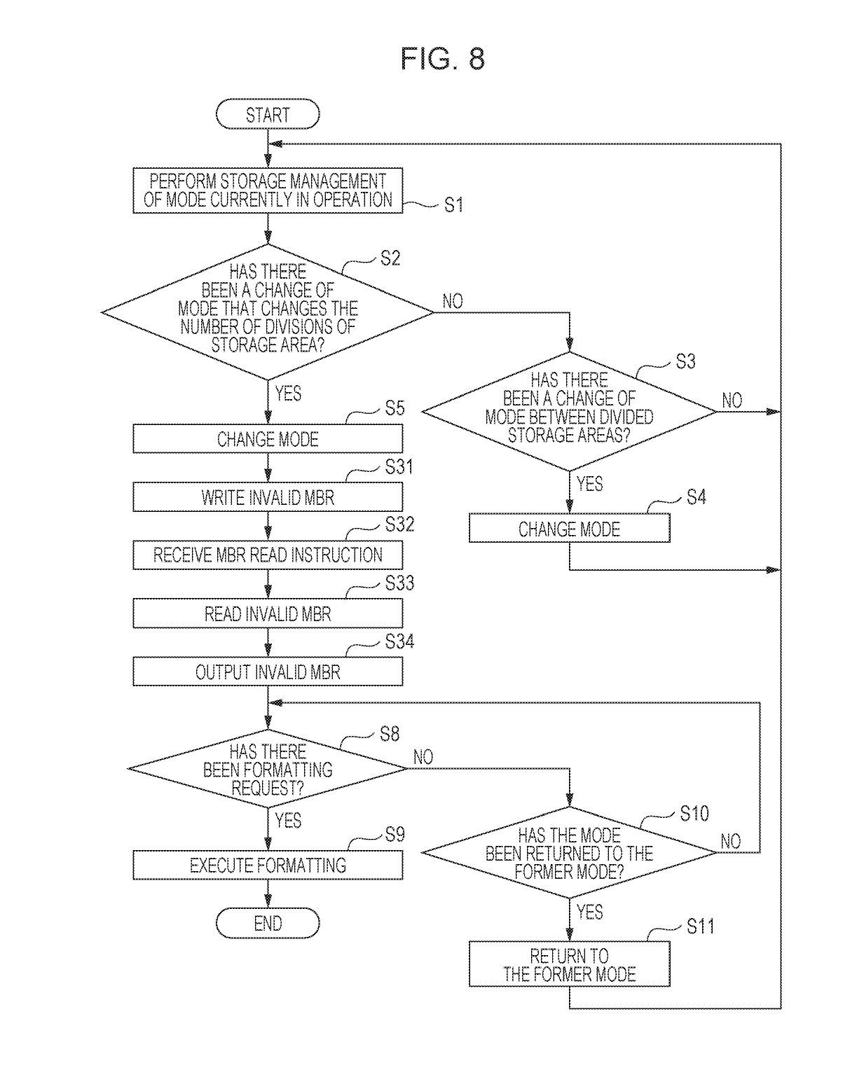

FIG. 8 is a flowchart for explaining an example of operation of a storage device according to a third embodiment of the present technique. The operation of the storage device according to the third embodiment of the present technique is the same as that of the first embodiment except that steps S31 to S34 are provided in place of the steps S6 and S7 illustrated in FIG. 5. Accordingly, a description will be only given of steps S31 to S34 in the following.

First, in step S31, the controller 11 writes an invalid MBR into the beginning sector (LBA=0 sector), which is the MBR area. The invalid MBR includes an invalid boot signature. The invalid MBR is generated by the controller 11, or stored and maintained in the storage section 14 in advance in the same manner as the first embodiment described above.

Next, in step S32, when the controller 11 receives a read instruction (for example, a read instruction of the beginning sector) of the MBR from the host apparatus 20, in step 33, the controller 11 reads the invalid MBR from the beginning sector. Next, in step S34, the controller 11 outputs the invalid MBR that has been read in step S33 to the host apparatus 20.

Advantages

By a storage device according to the third embodiment, it is possible to obtain the same advantage as those in the first embodiment described above.

### 4. Variations

In the above, a description has been specifically given of the first to the third embodiments of the present technique. However, the present technique is not limited to the first to the third embodiments described above, and various alterations are possible within the spirit and scope of the present technique.

For example, the configurations, the methods, the processing, the apparatuses, the devices, the numeric values, and so on described in the first to the third embodiments described above are only examples. A different configuration, method, processing, apparatus, device, and numeric value, and so on from those described above may be used as necessary.

Also, it is possible to combine each of the configurations, the methods, the processing, the apparatuses, the devices, the numeric values, and so on described in the first to the third embodiments with each other without departing from the spirit and scope of the present technique.

Variation 1

In the first to the third embodiments described above, descriptions have been given of the examples in which the mode change operation is performed by the operation section 13 of the storage device 10. However, the mode change operation in the storage device 10 is not limited to those examples. For example, the host apparatus 20 may include an operation section, and the mode of the storage device 10 may be changed by operation of this operation section. In this case, the operation section is not limited to a mechanical switch, and may be a virtual switch to be displayed on the host apparatus 20 or a display device connected to the host apparatus 20 on the basis of processing by software, and so on.

Variation 2

In the first to the third embodiments described above, descriptions have been given of the configuration in which the storage device 10 is externally connected to the host apparatus 20. However, the host apparatus 20 may internally includes the storage device 10. In this case, the processing of the flowcharts illustrated in FIG. 5, FIG. 7 and FIG. 8 is performed by the host apparatus 20.

Variation 3

In the first to the third embodiments described above, descriptions have been given of the examples of using the MBR as the division information (boot table). However, the division information (boot table) is not limited to those examples. For example, a GPT (GUID (Globally Unique Identifier) Partition Table) may be used. Also, in the first to the third embodiments described above, descriptions have been given of the case of using the LBA method as an access method to the storage medium 12. However, the access method is not limited to this. For example, a CHS (Cylinder/Head/Sector) method may be used.

Variation 4

In the first to the third embodiments described above, descriptions have been given of the cases where the storage device 10 has the whole mode and the division mode. However, the storage device 10 may have a plurality of division modes. In the plurality of division mode, for example, the number of divisions of the storage area, or the sizes of the division areas divided by the same number are different.

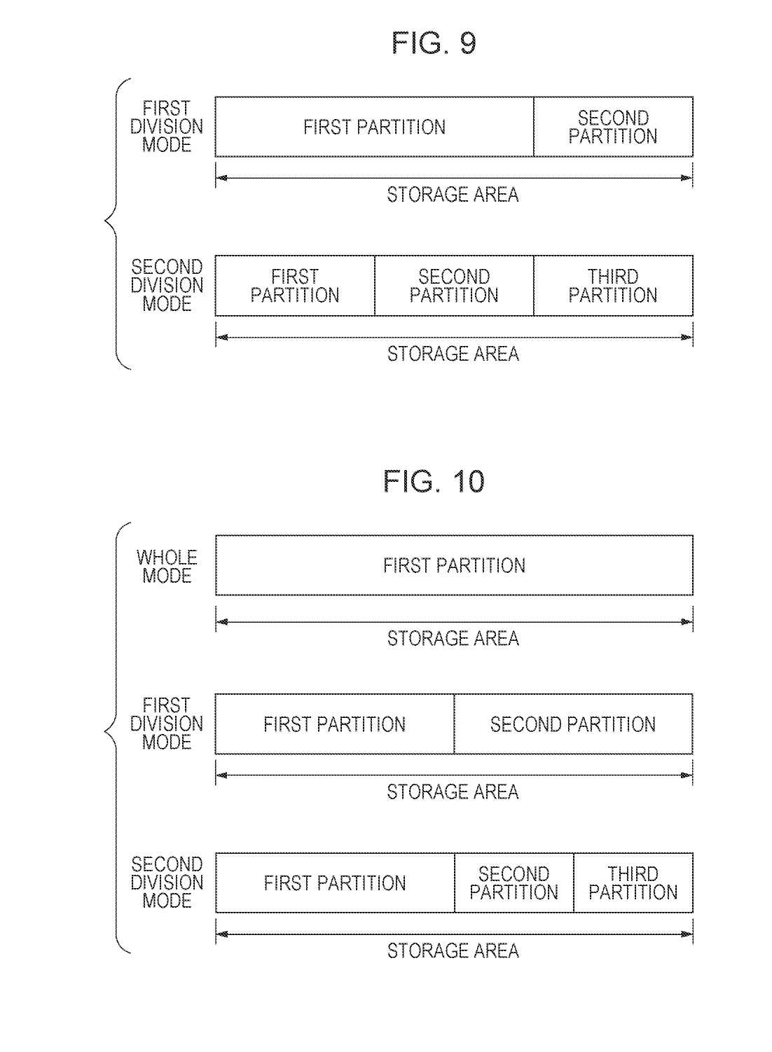

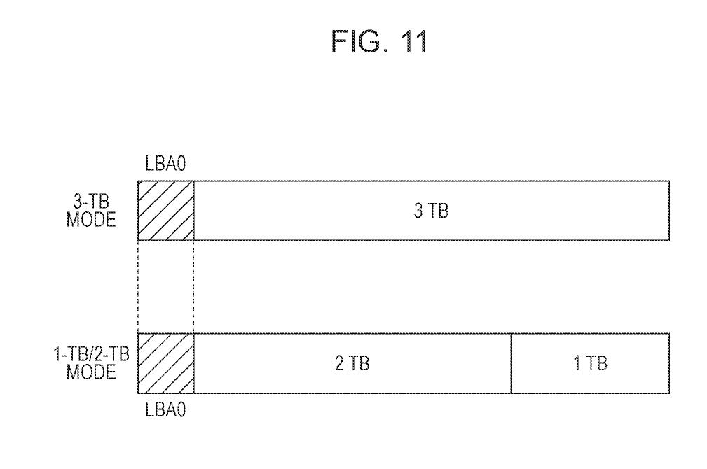

FIG. 9 is a diagram illustrating an example of a first division mode, and a second division mode. Between the first division mode and the second division mode, for example, the number of divisions of the storage area, or the sizes of the division areas divided by the same number are different. In this regard, FIG. 9 illustrates an example in which the number of divisions of the storage area are different.

Variation 5

In the first to the third embodiments described above, descriptions have been given of the cases where the storage device 10 has one whole mode and one division mode. However, the storage device 10 may have one whole mode and a plurality of division modes.

FIG. 10 is a diagram illustrating an example having a whole mode, a first division mode, and a second division mode. Between the first division mode and the second division mode, for example, the number of divisions of the storage area or the sizes of the division areas divided by the same number are different. In this regard, FIG. 10 illustrates an example in which the number of divisions of the storage area are different.

Variation 6

In the second embodiment described above, the controller 11 may write an invalid MBR in a MBR area located at the position corresponding to the mode after the mode change in accordance with the mode change, and may read the MBR, and output the MBR to the host apparatus 20.

Also, it is possible to employ the following configuration for the present technique.

(1) A storage device including: a storage medium; and a control section configured to prompt a host apparatus to perform formatting of the storage medium in accordance with a change of a number of divisions of a storage area of the storage medium.

(2) The storage device according to (1), wherein the storage medium is configured to store division information of the storage area of the storage medium, and prompting to perform the formatting is carried out by notifying the host apparatus that the division information is invalid.

(3) The storage device according to (1), wherein the storage medium is configured to store division information of the storage area of the storage medium and assurance information, and prompting to perform the formatting is carried out by outputting invalid assurance information to the host apparatus.

(4) The storage device according to (1), wherein the storage medium is configured to store division information of the storage area of the storage medium and assurance information, the control section is configured to rewrite the assurance information to invalid assurance information in accordance with the number of divisions of the storage area of the storage medium, and prompting the formatting is carried out by outputting the invalid assurance information to the host apparatus.

(5) The storage device according to (3) or (4), wherein the division information is a boot table, and the assurance information is a boot signature.

(6) The storage device according to (1), wherein the storage medium is configured to store assurance information, and prompting the formatting is carried out by reading information from a position shifted from a storage position of the assurance information before the change, and outputting the information to the host apparatus as the assurance information in accordance with the change of the number of divisions of the storage area of the storage medium.

(7) The storage device according to any one of (1) to (6), wherein the control section is configured to control a first mode for managing the storage area of the storage medium as a whole, and a second mode for managing the storage area of the storage medium by dividing the storage area, and the change of the number of divisions of the storage area of the storage medium is a change of modes between the first mode and the second mode.

(8) The storage device according to any one of (1) to (7), wherein the storage medium is configured to store division information of the storage area of the storage medium, and the control section is configured to hold the division information before the change until writing on the storage medium occurs after the change.

(9) A method of controlling a storage device, the method including: in accordance with a change of a number of divisions of a storage area of a storage medium, prompting a host apparatus to perform formatting of the storage medium.

What is claimed is:

1. A storage device comprising:
a storage medium; and
a control section configured to prompt a host apparatus to perform formatting of the storage medium in accordance with a change of a number of divisions of a storage area of the storage medium.

2. The storage device according to claim 1,
wherein the storage medium is configured to store division information of the storage area of the storage medium, and
prompting to perform the formatting is carried out by notifying the host apparatus that the division information is invalid.

3. The storage device according to claim 1,
wherein the storage medium is configured to store division information of the storage area of the storage medium and assurance information, and
prompting to perform the formatting is carried out by outputting invalid assurance information to the host apparatus.

4. The storage device according to claim 1,
wherein the storage medium is configured to store division information of the storage area of the storage medium and assurance information,
the control section is configured to rewrite the assurance information to invalid assurance information in accordance with the number of divisions of the storage area of the storage medium, and
prompting the formatting is carried out by outputting the invalid assurance information to the host apparatus.

5. The storage device according to claim 3,
wherein the division information is a boot table, and
the assurance information is a boot signature.

6. The storage device according to claim 1,
wherein the storage medium is configured to store assurance information, and
prompting the formatting is carried out by reading information from a position shifted from a storage position of the assurance information before the change, and outputting the information to the host apparatus as the assurance information in accordance with the change of the number of divisions of the storage area of the storage medium.

7. The storage device according to claim 1,
wherein the control section is configured to control
a first mode for managing the storage area of the storage medium as a whole, and
a second mode for managing the storage area of the storage medium by dividing the storage area, and
the change of the number of divisions of the storage area of the storage medium is a change of modes between the first mode and the second mode.

8. The storage device according to claim 1,
wherein the storage medium is configured to store division information of the storage area of the storage medium, and
the control section is configured to hold the division information before the change until writing on the storage medium occurs after the change.

9. A method of controlling a storage device, the method comprising:
in accordance with a change of a number of divisions of a storage area of a storage medium, prompting a host apparatus to perform formatting of the storage medium.
